(19) United States
(12) Patent Application Publication
(10) Pub. No.: US 2011/0113409 A1
(43) Pub. Date: May 12, 2011

(54) SYMBOL CAPABILITIES SUPPORT WITHIN ELF

(76) Inventors: Rodrick Evans, Palo Alto, CA (US); Ali Bahrami, Boulder, CO (US)

(21) Appl. No.: 12/616,088

(22) Filed: Nov. 10, 2009

(51) Int. Cl. G06F 9/45; G06F 9/44

(52) U.S. Cl. 717/140; 717/165

(57) ABSTRACT

Systems and methods for efficient compilation and execution of program code. A compiler generates a plurality of families of object files, wherein each family comprises a set of system capabilities different from a set of another family. A link-editor receives the object files and stores a symbol capabilities table in a symbol capabilities section of an object file with a new file format. A symbol is associated with one or more instances, wherein each instance is associated with a different set of capabilities. In various embodiments, system capabilities may include a particular operating system, special-function additional instructions, or otherwise. Subsequent to creation of the single object file with multiple instances of a given function, a runtime linker chooses a given instance based on the capabilities of the platform on which the code is to be executed.

### BACKGROUND OF THE INVENTION

1. Field of the Invention

This invention relates to computer systems, and more particularly, to techniques for efficient compilation and execution of program code.

2. Description of the Relevant Art

The performance of computer systems is dependent on both hardware and software. In addition to improving performance through new hardware design, new methods of software design are explored for improving computing performance. Regarding the hardware of a system, each generation of microprocessor design may provide additional hardware capabilities such as the execution of new instructions.

For example, an instruction set architecture (ISA) may expand to include the on-chip execution of additional instructions. In addition, software improvements for operating systems, compilers, and software products and packages are common. With the availability of new hardware and/or software capabilities, there is a desire to take advantage of these new capabilities in order to improve computing performance. One technique for increasing performance is for a user to write specialized code for particular platforms. For example, a software programmer may know source code is to be executed on a particular microprocessor that includes circuitry for cryptographic instructions or other multimedia instructions. In such a case, the developer may write code which uses these instructions.

Although source code may be written in a specialized manner for a particular platform, customers may shy away from the use of such code as it can run on some platforms but not others. Consequently, customers may simply opt for generic code that can run on a variety of systems and forego the potential benefits of more specialized code. One possible alternative is for a developer to provide a customer with a variety of object files, each supporting varying capabilities. In some cases, the object files may have a format that permits identification of the required system capabilities needed for an object file of a particular version to execute. A first family of provided object files from the developer may correspond to the system capabilities of a first platform. A second family of provided object files from the developer may correspond to the system capabilities of a second platform. Depending on the capabilities of the platform upon which they run, the appropriate object may be chosen at runtime.

As an example, a first version of source code may include a function that utilizes particular multimedia instructions. A second version of the object may include a version of the same function that does not utilize the multimedia instructions. Each version may then have a corresponding compiled object that includes an indication as whether or not the multimedia instruction capability is required for execution of the object. This information may then be used at runtime (e.g., by a runtime linker) to select the appropriate object. If a particular platform does not support execution of the these multimedia instructions, then during the dynamic linking stage, the object files of the first version may not be loaded. Instead, the corresponding object for the second version may be chosen automatically during the dynamic linking stage.

In the case of objects which use the Executable and Linking object file Format (ELF), a given dynamic object may include only a single instance of a given symbol. Consequently, should multiple instances of a given symbol be desired, a separate object is required for each of the instances.

Consequently, there may be a relatively large cost to providing the packaging necessary to coordinate such families of objects. There may also be a high runtime cost of selecting and loading from this family.

In view of the above, efficient methods and mechanisms for automatically selecting a most-appropriate version of code for a computing platform are desired.

### SUMMARY OF THE INVENTION

Systems and methods for efficient compilation and execution of program code are contemplated.

In one embodiment, a compiler is configured to generate a plurality of families of object files. Each family comprises a set of system capabilities different from a set of another family. A link-editor is coupled to receive the plurality of families of object files. In one embodiment, the object files utilize the Executable and Linking object file Format (ELF). In one embodiment, the link-editor is configured to support multiple instances of a given symbol within a given dynamic object. In such an embodiment, the link editor includes a symbol capabilities section in the object. This section(s) is configured to associate multiple instances of a symbol with a corresponding set of hardware and/or software capabilities. In various embodiments, system capabilities may include a particular operating system, special-function additional instructions, or otherwise.

Subsequent to creation of the single object file with multiple instances of a given symbol, a runtime linker may choose a given instance from a single dynamic object based on the capabilities of the platform on which the code is to be executed. In one embodiment, selection of the given instance may be based on determining the associated instance has the most matches of system capabilities with the system capabilities of a platform for executing the code.

### BRIEF DESCRIPTION OF THE DRAWINGS

FIG. 1 is a generalized block diagram illustrating one embodiment of an overview for software program compilation and execution on separate systems.

FIG. 2 is a generalized block diagram illustrating one embodiment of an object file format.

FIG. 3 is a generalized flow diagram illustrating one embodiment of a method for packaging multiple instances of a symbol.

FIG. 4 is a generalized flow diagram illustrating one embodiment of a method for automatically selecting a most-appropriate version of code for a computing platform.

FIG. 5 is a generalized block diagram illustrating one embodiment of an overview of software components and process.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

In the following description, numerous specific details are set forth to provide a thorough understanding of the present invention. However, one having ordinary skill in the art should recognize that the invention may be practiced without these specific details. In some instances, well-known circuits, structures, signals, computer program instructions, and techniques have not been shown in detail to avoid obscuring the present invention.

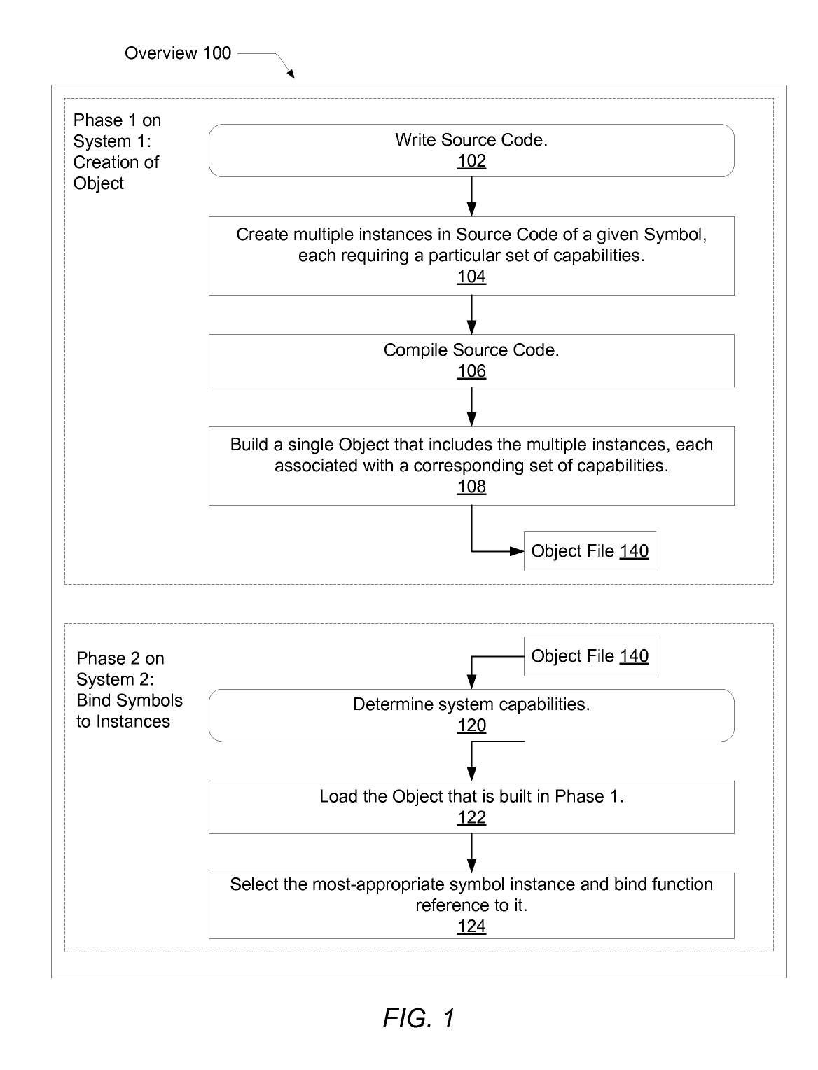

Turning now to FIG. 1, one embodiment of an overview 100 for code compilation and execution is shown. As can be seen in FIG. 1, development of source code and compilation may occur during a first phase on a first computing system. A collection of object files may then be bundled together and provided to customers. The customers may load and execute the provided object files in a second phase on a separate second computing system.

Referring to the first phase, a software developer writes source code in block 102. The source code may be written in a high-level language such as C, C++, Fortran, or otherwise. The source code may be written to perform predetermined steps of an algorithm or method. One or more libraries may be used during the software development. These libraries, which could also be written by the software developer, may include code and data that describe one or more subroutine definitions. These subroutines may be referenced for use by code in other files such as through a function call. As is well known to those skilled in the art, this function call may be represented by a symbol. The libraries may allow the sharing and changing of code and data in a modular fashion. The libraries may utilize references to connect to executable files. A link-editor and a runtime linker may typically perform linking processes. The source code written by a developer may be executed on a variety of machines. In various embodiments, a machine may refer to a computer, a mobile phone, a personal digital assistant (PDA), a server, or otherwise. A machine may include one or more processors comprising one or more processor cores.

In block 104, software developers may create multiple instances in the source code of a given symbol, each instance requiring or utilizing a particular set of capabilities. Each different system of a given architecture may have different hardware and software capabilities. Capabilities identify the attributes of a system that may allow code to execute. Capabilities may identify extensions to an ISA, enhancements to debugging and monitoring processes, restrictions on address space, or otherwise. For example, a developer may write source code for a symbol foo( ) (e.g., a function) that utilizes instructions that are an extension to an ISA. This first instance of the symbol foo( ) may be provided in a first library. Then the software developer may write source code for the symbol foo( ) that does not utilize the instructions that are an extension to the ISA. This second instance may be provided in a second library.

In block 106, the source code may be compiled. This source code may be stored on a computer readable medium. A command instruction, which may be entered at a prompt by a user with any necessary options, may be executed in order to compile the source code. A compiler may generate one or more object files in response to compiling the computer program, or source code. One or more versions of source code may be written in a specialized manner for a particular platform. As used herein, a “system”, or “platform”, may refer to a computing platform for executing software applications, wherein a platform includes at least a computer instruction set architecture (ISA), extensions to the ISA, a particular microprocessor, a particular operating system, compilers, related runtime libraries, and related device drivers for input/output (I/O) peripherals.

Source code that may only be executed when certain capabilities are available on a platform, such as an extension to an ISA, may identify these certain capabilities. One example of identifying capabilities is by means of a capabilities section within an associated object file. Recording capabilities requirements within an object may allow a system to validate an object file before attempting to execute the associated code. These identified capabilities may also provide a framework that allows a system to automatically select a most-appropriate object file for a given computing platform.

In block 108, a link-editor may utilize the multiple object files that are output from a compiler. In one embodiment, these object files include a section that identifies requested system capabilities and the link-editor may build a single corresponding object file that includes multiple instances of a symbol. Additionally, the object may associate corresponding capabilities with each of the multiple instances in a symbol capabilities section of the object. Therefore, the link-editor may receive multiple object files that identify required capabilities at an object-level and produce multiple object files that identify required capabilities at a symbol-level. Object file 140 represents an object file output by a link-editor utilizing a new file format to identify required capabilities at a symbol-level. It is noted that a link-editor may generally produce many object files and the single object file 140 is used for illustrative purposes. The single object 140 may then be provided to a customer as part of a larger package.

In block 120, a runtime linker may determine the system capabilities of a corresponding platform. This corresponding platform may be configured to execute the object files generated by the steps in phase 1 shown above. In one embodiment, the system capabilities of the platform may be conveyed by the kernel of the platform. In block 122, the runtime linker used for dynamic linking may load the provided object files, such as object file 140. In one embodiment, object files that are loaded may also include an object capabilities section that identifies capabilities that are also supported by the corresponding platform. An example of this requirement might be the identification of code that requires the MMX or SSE features that are available on some x86 architectures. Another example of a requirement is the SPARC VIS2 instructions. Any hardware capability requirements defined by an object may be validated by the runtime linker against the hardware capabilities that are available from a platform. If any of the hardware capability requirements cannot be satisfied, the object may not be loaded at runtime. For example, if the SSE feature is not available to a process, an indication of an error may be conveyed.

In one embodiment, the runtime linker may bind each symbol, or function reference, to a global instance which may be used as a default binding. The runtime linker may be configured to perform this binding at various times throughout the life of a corresponding process. For example, in one embodiment, the runtime linker may be configured to bind a reference to a particular instance of multiple instances only at the time it is called during execution of a process.

When multiple instances of a given symbol are present in a single dynamic object, then a selection process may be undertaken. In block 124, the runtime linker may select a most-appropriate instance of a symbol by choosing from a given family based on the provided capabilities of a given platform. The platform capabilities may be provided to the runtime linker from the kernel. In one embodiment, the runtime linker may select a most-appropriate family of instances, wherein this family includes the most-appropriate symbols.

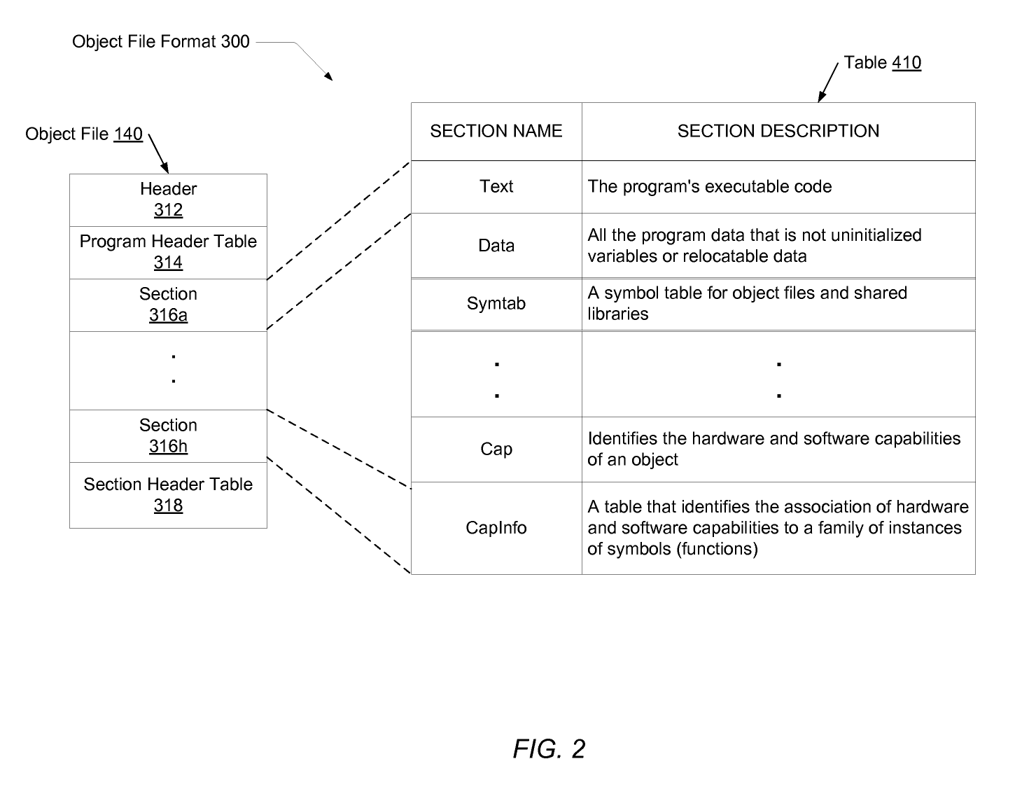

Turning now to FIG. 2, one embodiment of an object file format 300 is shown. In one embodiment, an Executable and Linking Format (ELF) may be used for object files, wherein an ELF object file may be a portable object file format. The ELF object file format is one example of a portable object file format for executable files, object files, and libraries.

An ELF file format may aid developers by providing a set of binary interface definitions that are cross-platform and by making it easier for tool vendors to port to multiple platforms. Having a standard object file format also makes porting of object-manipulating programs easier. Compilers, debuggers, and linkers are some examples of tools that may use the ELF format.

The ELF specification describes three kinds of object files. First, relocatable files hold code and data suitable for linking with other object files. Relocatable files may have a filename extension of .o and may be generated by a compiler during compilation of source code. These object files may also be referred to as input object files or intermediate object files, since they are generated by a compiler and input to a link-editor. These intermediate object files may be processed by the link-editor to produce either an ELF executable or shared object files or shared libraries, such as dynamically linked libraries (DLLs).

Second, executable object files hold code and data that can be executed on the target operating system. Third, shared objects hold relocatable data that can be shared by one or more programs.

In one embodiment, an ELF header 312 resides at the beginning of an ELF object file 140 and holds a directory, or map, describing the file's organization and locations of other parts of the file. In one embodiment, the ELF header 312 may have a fixed position within the file 140. The flexibility of the ELF format 300 may lack a specified order for other components of the file 140. As known to those skilled in the art, the ELF header 312 has a data structure, indicated by a typedef struct statement, declaring multiple sections, which are arrays that provide information about the data representation of the object file structures. These sections may determine the object file type (e.g. relocatable, executable, shared object); a specified architecture (e.g. SPARC, Intel 80386, AMD64); an entry number indicating a virtual address to which the system may first transfer control, which begins a process; a number of entries in the section header table 318; processor-specific flags such as extensions to an ISA, store ordering and memory ordering styles, and other supported features; and other.

The ELF format provides an object file framework to support multiple processors, multiple data encoding, and multiple classes of machines. To support this object file family, the initial bytes of the file may specify how to interpret the file. These bytes are independent of the processor on which the inquiry is made and independent of the file's remaining contents.

A program header table 314, if present, may indicate to the system how to create a process image. This table describes the loadable sections and other data structures utilized for loading a program or dynamically-linked library in preparation for execution. The program header table may contain a list of entries describing each segment. Files used to generate a process image, such as executable files and shared objects, have a program header table. Relocatable object files may not have a program header table 314.

Sections 316 may represent the smallest indivisible units that may be processed within an ELF object file 140. Sections may contain important data for linking and relocation. As known to those skilled in the art, this data may include instructions, data, a symbol table, and relocation information. Each section of an ELF file has a name that identifies its purpose. Segments are a collection of sections and may represent the smallest individual units that can be mapped to a memory image by a runtime linker. Segments may contain information that is necessary for runtime execution of the file. A section header table 318 may contain information describing the file's sections. Each section 316 may have an entry in the table 318. Each entry within table 318 may provide information such as the section name and section size.

In one embodiment, an object file may comprise one or more sections shown in Table 410. In another embodiment, an object file may comprise additional sections not shown in Table 410. The Text section may include the program's executable code. Both the data section and other sections not shown may contain the different types of data used during the program's execution.

The Symtab section may store an object file's symbol table. The symbol table may hold information used to locate and relocate a program's symbolic definition and references. A symbol table subscript value may be used as an index into this array. This section may contain a list of all of the symbols, such as program entry points, addresses of variables, and other, that are defined or referenced within the file. Also this section may include an address associated with the symbol and a tag indicating the type of the symbol. In one embodiment, a feature of an ELF object file is that its shared libraries resolve symbols and externals at run time. This is done using a symbol table and a list of relocations, which may be performed before the image can start to execute. A number of optimizations built into the ELF object file format may make these steps fairly fast. When a position-independent code is compiled into a shared library, there are generally few relocations, which is another reason the performance impact may not be of great concern.

The Cap section may be used to identify the hardware and software capabilities of an object file. In one embodiment, a Cap structure is utilized which comprises multiple capabilities definitions. In one embodiment, the Cap structure uses a null terminated array of capabilities definitions. In other embodiments, other data structures may be utilized. In the prior art, an ELF file could only have one such structure, and that one structure defined the capabilities requirements of the entire ELF file. With the methods and mechanisms described herein, the Cap section is modified to allow for multiple Cap structures. Symbols may then be associated with these additional Cap structures, which in turn permits these symbols to identify their respective capabilities.

A CapInfo section in the object may allow individual symbols to be associated with required system capabilities via adjunct symbol table information. This new section, CapInfo, may aid in providing the creation of a family of instances of a given function, represented by its symbol, within an object file. Each of these instances may be associated with different capabilities. Now, a single object file may provide many instances of a function (symbol), foo( ) each instance associated with different required system capabilities. Later at runtime, the most-appropriate instance of a function may be selected.

In one embodiment, a Capinfo entry includes the Cap index (e.g., [0], [1], [2], etc.) for the associated symbol. A Symbol Table (Symtab) will include corresponding entries [0], [1], [2], which define the corresponding symbol information. In one embodiment, the Capinfo entries do not duplicate the Symtab entries but are read in parallel with the Symtab entries. One embodiment of a portion of a section is provided below:

Hardware/Software Capabilities Section: .SUNW_cap
Symbol Capabilities:
index tag value
[1]CA_SUNW_HW_1 0x840 [SSE MMX]
Symbols:
index value size type bind oth ver shndx name
[25] 0x00000000 0x00000021 FUNC LOCL D 0 .text foo
[26] 0x00000024 0x0000001e FUNC LOCL D 0 .text bar
Symbol Capabilities:
index tag value
[1] CA_SUNW_HW_1 0x9000 [MON SSE2]
Symbols:
index value size type bind oth ver shndx name
[27] 0x00000048 0x00000021 FUNC LOCL D 0 .text foo
[28] 0x0000006c 0x0000001e FUNC LOCL D 0 .text bar

In the example above, the symbol information “FUNC”, “LOCL” etc, is information that generally already exists in the Symtab. For example, for the first line which has symbol index 25, the CapInfo section will have an entry, at index 25, which will point to the Cap descriptor starting at Cap[1].

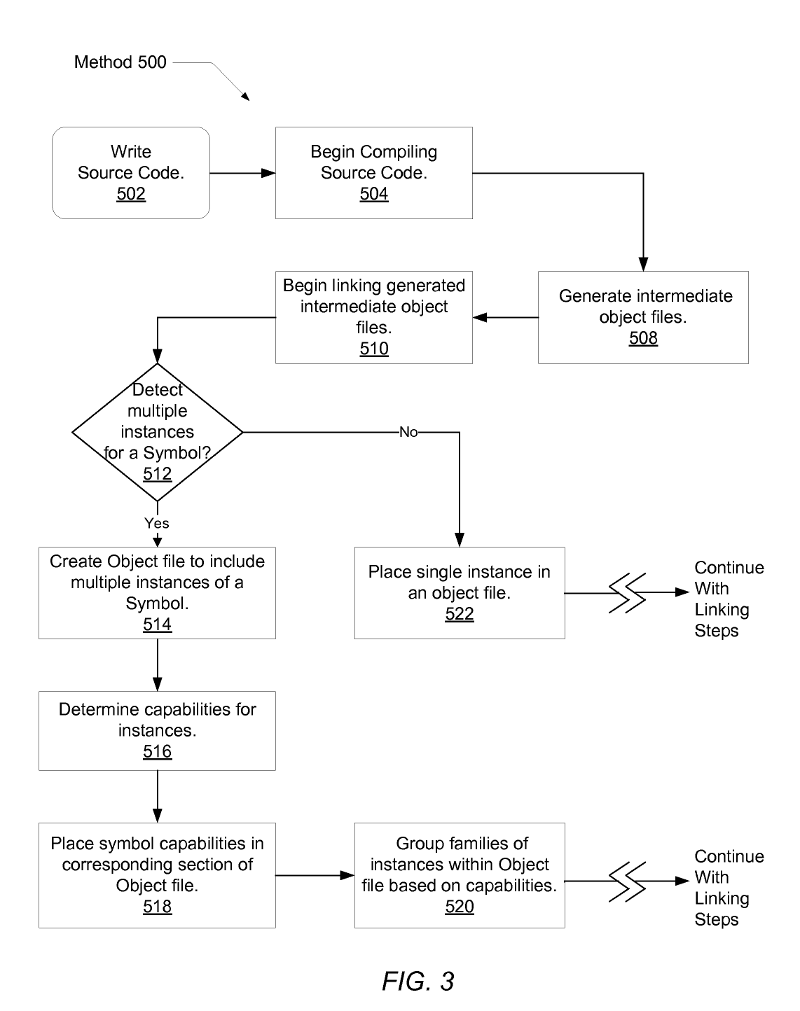

Turning now to FIG. 3, one embodiment of a method 500 for automatically packaging multiple instances of a symbol is shown. Method 500 may be modified by those skilled in the art in order to derive alternative embodiments. Also, the steps in this embodiment are shown in sequential order. However, some steps may occur in a different order than shown, some steps may be performed concurrently, some steps may be combined with other steps, and some steps may be absent in another embodiment. Method 500 may describe in further detail the steps shown in phase 1 of FIG. 1. In the embodiment shown, software applications may be written by a developer in a high-level language such as C, C++, Fortran, or other in block 502. This source code may be stored on a computer readable medium. A command instruction, which may be entered at a prompt by a user, with any necessary options may be executed in order to compile the source code.

Software developers may create multiple instances in the source code of a given symbol, each instance requiring a particular set of capabilities. Each different system of a given architecture may have different hardware and software capabilities. For example, a developer may write source code for a symbol foo( ) that utilizes instructions that are an extension to an ISA. This first instance of the symbol foo( ) may be provided in a first library. Then the software developer may write source code for the symbol foo( ) that does not utilize the instructions that are an extension to the ISA. This second instance may be provided in a second library.

In block 504, compilation of the source code may begin. A compiler may include a set of programs for translating the source code into another computer language, or target code. In one embodiment, the target code may be machine code. Machine code is a general term that refers to patterns of bits with different patterns corresponding to different commands, or instructions, to the machine, or processor.

Most modern compilers may be split into a number of relatively independent phases, or passes. Separate phases allow one or more phases to be later improved or replaced, and additional phases may later be inserted to permit additional optimizations. Although modern compilers have two or more phases, these phases are usually regarded as being part of the front-end or the back-end. There is not a hard boundary of responsibilities between these two phases. Generally speaking, the front-end performs syntactic and semantic processing and translates the source code to a lower-level representation. Also optimizations may be performed on this representation. The independence provided by the lower-level representation of the source code from the machine code may allow generic optimizations to be shared between versions of the compiler.

The back-end compiler may take the output from the front-end compiler and performs more analysis, transformations, and optimizations for a particular platform. A processor may be designed to execute instructions of a particular instruction set architecture (ISA), and the processor may have one or more processor cores. The manner in which a software application, such as source code, is executed in order to reach peak performance may differ greatly between a single-, dual-, or quad-core processor. Regardless, the manner in which to compile the software application in order to achieve peak performance may need to vary between a single-core and a multi-core processor.

Basic components of a back-end portion of a compiler may include a processor core selection unit for determining the number of available hardware threads and assigning software threads to the available hardware threads, a preprocessor for dividing instructions into basic components, an optimizer for performing transformations and optimizations after an analysis step, and a code generator for conveying object files as an output. An advantage of splitting the front-end of a compiler from the back-end is front-ends for different languages may be combined with back-ends for different processors.

In block 508, in one embodiment, near the end of the compilation process and the generation of the intermediate object files, the capabilities object files are determined that are used to group together families of intermediate object files. A software developer may amend or add and delete the capabilities that are recorded in an intermediate object file as it is being built. A mapfile may be used to provide this information. Also, an operating system may provide a means of providing more information using an input file, which may or may not be designated as a “mapfile” In addition, the compiler may determine the capabilities as it analyzes the instructions within the source code.

In block 510, a link-editor receives the generated intermediate object files from the compiler and begins linking these object files. During linking, the link-editor may build object files that may be sent to customers to be executed on different platforms. The building process may include transforming and combining sections within the intermediate object files. If multiple instances of any symbol are not detected in the intermediate object files (conditional block 512), then in block 522, a single instance of each symbol is placed in a corresponding object file that may be linked to other object files, such as libraries. Then other steps of the linking process are performed to prepare object files which may then be conveyed to customers.

If multiple instances of a symbol are detected in the intermediate object files (conditional block 512), then in block 514, an object file is created that may have a file format as shown in FIG. 2. This file format may have a section that indicates the required capabilities of symbols within one or more intermediate object files, such as the CapInfo section. In block 516, the required capabilities of the symbols are determined and populated, or placed, in the CapInfo section in block 518. This determination may be performed in a similar manner as the determination of capabilities at the object file level.

The link-editor is creating an object file comprising multiple instances for a particular function call, or symbol, such as foo( ). In block 520, each instance may be grouped in a family with other instances of other symbols, wherein each instance of the family is associated with a same set of required capabilities. In one embodiment, this family of instances may be tagged appropriately, which may be later conveyed to a runtime linker via a standard hash table.

When the object files generated by the link-editor are conveyed to customers, the customers now may load the files and execute them on several various platforms. Before doing so, in one embodiment, the kernel inspects the binary, such as the object files generated by the link-editor. Then the kernel loads this binary into the user's virtual memory. If the application, or the object files, is linked to a shared library, the application may also contain the name of the dynamic linker, or runtime linker, that should be used. The kernel may then transfer control to the runtime linker, not to the application. Generally speaking, the runtime linker may be responsible for first initializing itself, loading the shared libraries into memory, resolving all remaining relocations, and then transferring control to the application. In the object file, a particular section, such as an .interp section, may contain an ASCII string that is the name of the runtime linker.

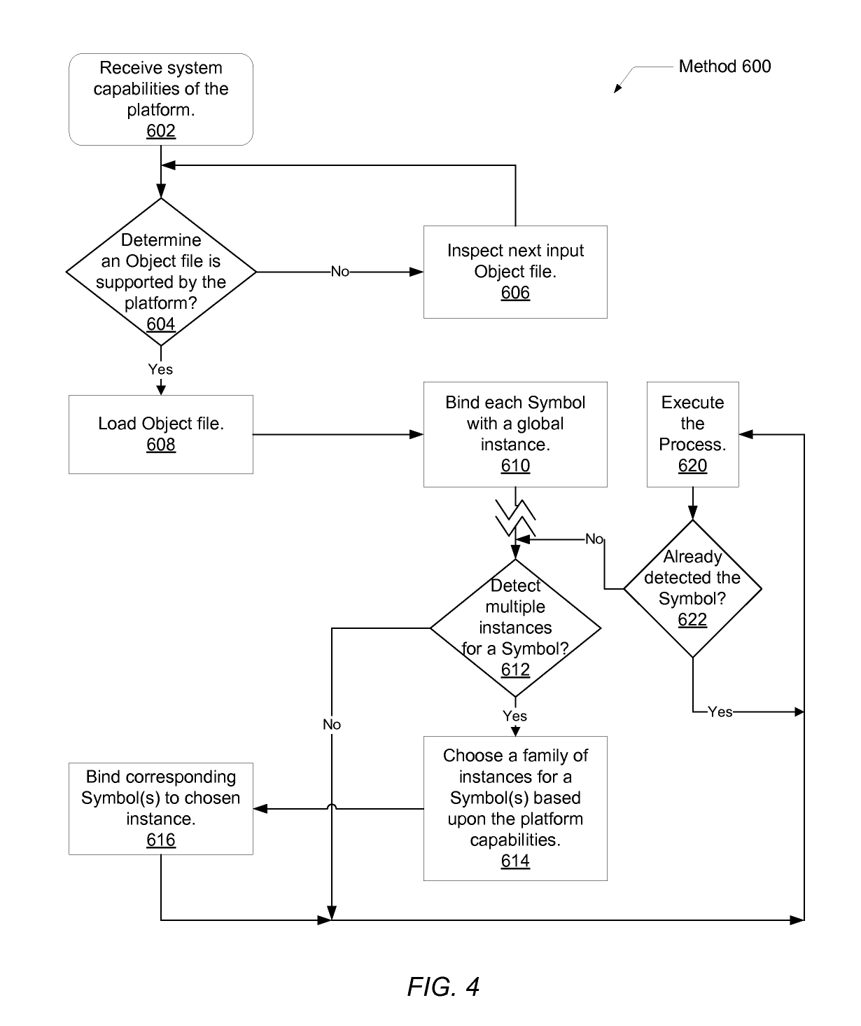

Referring now to FIG. 4, one embodiment of a method 600 for automatically selecting a most-appropriate instance of a symbol for a computing platform is shown. Similar to other methods described above, method 600 may be modified by those skilled in the art in order to derive alternative embodiments. Also, the steps in this embodiment are shown in sequential order. However, some steps may occur in a different order than shown, some steps may be performed concurrently, some steps may be combined with other steps, and some steps may be absent in another embodiment. Method 600 may describe in further detail the steps shown in phase 2 of FIG. 1. In the embodiment shown, in block 602, an operating system of the platform may convey flags, or indications, of the hardware and software capabilities of the corresponding platform. In one embodiment, the runtime linker receives these indications from the kernel.

As noted earlier, in order for particular object files to be loaded and to execute, these object files may require particular system capabilities, which may include both hardware and software capabilities. The hardware capabilities may include one or more of at least the instructions of an ISA, the instructions of extensions to the ISA, or otherwise. An example may be Intel® streaming simultaneous instruction multiple data (SIMD) extensions (SSE). This instruction set is an extension to the x86 architecture. The software capabilities may include, at least, one or more of the characteristics used for debugging or monitoring processes, frame pointer usage state of an object file, and predetermined restrictions on address space.

If it is detected that an object file indicates object capabilities supported by the platform (conditional block 604), then the object file is loaded in block 608. It is noted that a platform that does not support multimedia instruction extensions, for example, may be able to load a corresponding instance of a symbol foo( ) within an object file if that instance does not use the instruction extensions. However, another instance of foo( ) may be located within this same object file, wherein this other instance is associated with a different second family of instances that does use the instruction extensions. Therefore, when building an object capabilities section, such as in the Cap section within a file format as depicted in FIG. 2, this section may not be restrictive and list all capabilities supported by all instances within the object file. Rather, a generic list of capabilities may be chosen in order to ensure that the object file is loaded.

If it is detected that an object file indicates object capabilities not supported by the platform (conditional block 604), then the object file is not loaded in block 606 and a next object file is inspected. A corresponding error or warning message may be conveyed to the user. Each symbol within a loaded object file may originally be bound to a global instance in block 610. If a symbol is not associated with multiple instances (conditional block 612), then the global instance may be maintained.

When binding a reference to a family, the runtime linker may be aware that the family is assigned capabilities, and may search the single executable object file for a most appropriate instance (i.e., one that uses the best available capabilities provided by the platform). For example, the runtime linker may receive flags, or indications, from kernel that indicate the hardware and software capabilities of a particular platform. As vendors offer new processors and new machines and systems, these flags may be updated. The runtime linker may now receive a single executable object file and load any required shared object files and bind them together. Typically, a call to foo( ) from one object file gets bound to the definition of the function foo( ) within another object file. The runtime linker may not load a function definition associated with capabilities that are inappropriate for a corresponding platform on which the runtime linker is running. However, now with a single executable object file, the runtime linker may select between concatenated instances of a function represented by symbols rather than select definitions in other object files.

The runtime linker may be able to match up the capabilities assigned to a family and the capabilities provided by a platform. The symbol tables, hash tables, and capabilities information may be laid out so that the runtime linker may identify the symbol capabilities, and select the most-appropriate instance at runtime. Then the runtime linker may convey a final executable file.

The symbol capabilities described above may be layered over the present required system capabilities infrastructure in a manner that is both compatible with existing structures, while extending capabilities association to a per-symbol basis. This mechanism may allow many system-related libraries to be implemented using symbol capabilities rather than the existing required system capabilities. Using symbol capabilities may provide a simpler and more efficient runtime environment, and remove a number of packaging/support issues with present deliverables.

In one embodiment, a compiler may be able to auto-construct object files that can take advantage of system capabilities transparent to the user. The compiler may compile an individual symbol into multiple instances, each using different instructions or providing a different implementation of a same algorithm. These instances may then be placed in a same object file offering the customer optimized routines that may be used transparently at runtime on the appropriate platforms.

If a symbol is associated with multiple instances (conditional block 612), then in block 614, the corresponding system capabilities of each instance may be compared to the system capabilities of a platform. The capabilities of the symbols may be stored in the CapInfo section as shown in FIG. 2. The capabilities of the platform may have been conveyed by the kernel as discussed above. A most-appropriate instance of a given symbol may be chosen based upon this comparison. This selection process of a most-appropriate instance for a symbol within the object file may continue for each symbol associated with multiple instances. In one embodiment, instances of separate symbols are grouped together in families based on required capabilities. The runtime linker may choose a most-appropriate family based on the comparison and then a most-appropriate instance is now chosen for each symbol within the family. In block 616, a symbol may be bound to the selected instance. Then control flow of method 600 moves to block 620 wherein a process is executing the dynamically loaded binaries of the object files. During execution, if a reference to a function, its symbol, is reached for the first time (conditional block 622), then control flow of method 600 moves to conditional block 612. Otherwise, control flow returns to block 620 and the process continues executing.

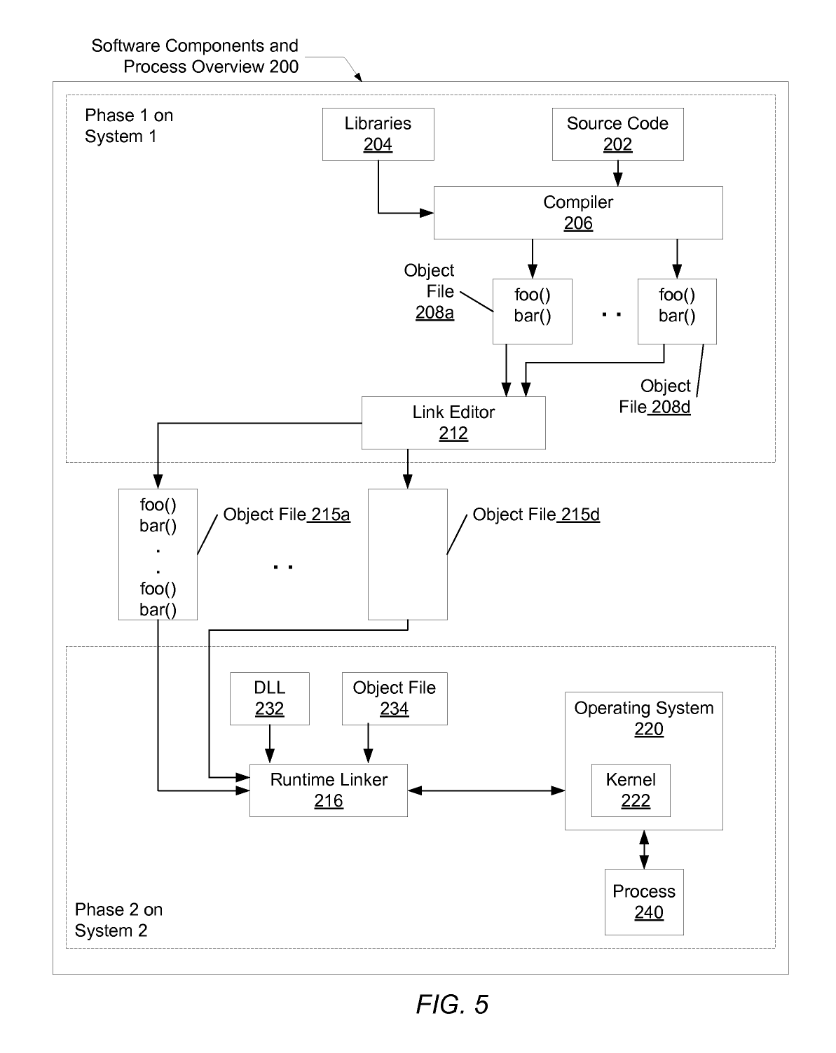

Turning now to FIG. 5, one embodiment of a system 200 for efficient support for specialized code execution is shown. In the embodiment shown, components are shown for implementing the operations described for the two phases in FIG. 1. A developer writes source code 202, which may include multiple instances for a same symbol.

In one embodiment, source code 202 may be specialized code. A software programmer may write specialized code in order to increase performance for a particular algorithm being executed on a particular platform. Alternatively, a user may re-compile generic code using compiler 206 with various different compiler flag settings in order to generate intermediate object files 208 corresponding to specialized code. With either method, a compiler 206 may generate a single specialized instance of a given object file 208. An instance of an object file may be associated with a set of capabilities different from another object file. After compilation, one set, or family, of object files may exist for each corresponding set of identified capabilities. This single set of object files may be referred to as a single family of object files.

Compiler 206 compiles the source code 202 and generates intermediate object files 208a-208d. As used herein, elements referred to by a reference numeral followed by a letter may be collectively referred to by the numeral alone. For example, object files 208a-208d may be collectively referred to as object files 208.

As can be seen in FIG. 5, the intermediate object files 208 may include multiple instances of a same symbol, such as foo( ) and bar( ). Each instance may correspond to a different set of capabilities. Object files associated with a same set of capabilities may be grouped into a same family. For example object file 208a may be associated with a first family of objects and object file 208d may be associated with a second family of objects.

Link-editor 212 may receive the generated intermediate object files 208 and build object files 215. Link-editor 212 may be configured to first create object files with a file format with a section indicating required capabilities at a symbol level. The CapInfo section in FIG. 2 is an example. Also, link-editor 212 may be configured to place multiple instances associated with a same symbol in a same object file 215. This placement is shown in FIG. 5 with the symbols foo( ) and bar( ). The first listing or placement of these symbols may be associated with a first family of symbol capabilities. The second placement may be associated with a different second family of symbol capabilities. Each family may be tagged appropriately for a runtime linker to perform a later selection.

An associated runtime linker 216 that is loaded receives these object files 215 as input in addition to possibly other dynamically linked libraries (DLL) 232 and any other shared dynamic object files 234. In one embodiment, dynamic loading may be used in order to provide a single binary release that may be used by developers and production release teams. The same binary executable the application is developed and tested against may be the same binary executable placed into production. A single check sum may verify the images match. Kernel 222 within the operating system 220 of a platform conveys indications of the capabilities of the platform. Runtime linker 216 performs a selection of families of instances of symbols (e.g. select either the first family of foo( ) and bar( ) or select the second family of foo( ) and bar( ). Once selected, the symbol is bound to an appropriate location in memory, or a reference. Then an executing process 240 uses the binaries of the selected definition, or instance, of the corresponding symbol.

It is noted that the above-described embodiments may comprise software. In such an embodiment, the program instructions that implement the methods and/or mechanisms may be conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A computer implemented method comprising:
compiling program code to generate a plurality of objects, each of said plurality of objects comprising a given symbol; and
utilizing said objects to create a single dynamic object, said dynamic object including multiple instances of the given symbol;
wherein within said single dynamic object, each of said multiple instances of the given symbol is associated with one or more corresponding hardware and/or software capabilities of a computing platform.

2. The method as recited in claim 1, wherein said single dynamic object is created by a link-editor.

3. The method as recited in claim 1, wherein said dynamic object is created according to an Executable Linking Format (ELF).

4. The method as recited in claim 3, further comprising:
loading said dynamic object at runtime on a given computing platform;
determining capabilities of the given computing platform; and
binding the given symbol to a particular one of said multiple instances in the dynamic object.

5. The method as recited in claim 4, further comprising selecting said particular one of the multiple instances based upon a comparison of the capabilities of the given computing platform and capabilities associated with said multiple instances in the dynamic object.

6. The method as recited in claim 5, wherein said capabilities comprise at least one of the following: the instructions of an instruction set architecture (ISA), the instructions of extensions to the ISA, software features for debugging and monitoring processes, and frame pointer usage state of an object file.

7. The method as recited in claim 4, wherein said dynamic object further comprises a global instance of the given symbol, and wherein the method comprises:
initially binding the symbol to the global instance; and
binding the given symbol to said particular one of the multiple instances, responsive to a first reference to the given symbol during execution.

8. A computing system comprising:
a compiler configured to compile program code to generate a plurality of objects, each of said plurality of objects comprising a given symbol; and
a linker configured to utilize said objects to create a single dynamic object, said dynamic object including multiple instances of the given symbol;
wherein within said single dynamic object, each of said multiple instances of the given symbol is associated with one or more corresponding hardware and/or software capabilities of a computing platform.

9. The computing system as recited in claim 9, wherein at least two of said multiple instances are not both operable on a same computing platform.

10. The computing system as recited in claim 10, wherein said dynamic object is created according to an Executable Linking Format (ELF).

11. The computing system as recited in claim 11, further comprising a runtime component configured to:
load said dynamic object at runtime;
determine capabilities of the computing system; and
bind the given symbol to a particular one of said multiple instances in the dynamic object.

12. The computing system as recited in claim 12, wherein said runtime component is further configured to select said particular one of the multiple instances based upon a comparison of the capabilities of the computing system and capabilities associated with said multiple instances in the dynamic object.

13. The computing system as recited in claim 13, wherein said capabilities comprise at least one of the following: the instructions of an instruction set architecture (ISA), the instructions of extensions to the ISA, software features for debugging and monitoring processes, and frame pointer usage state of an object file.

14. The computing system as recited in claim 12, wherein said dynamic object further comprises a global instance of the given symbol, and wherein the component is configured to:
initially bind the symbol to the global instance; and
bind the given symbol to said particular one of the multiple instances, responsive to a first reference to the given symbol during execution.

15. A computer readable storage medium comprising program instructions, wherein said program instructions are executable to:
compile program code to generate a plurality of objects, each of said plurality of objects comprising a given symbol; and
utilize said objects to create a single dynamic object, said dynamic object including multiple instances of the given symbol;
wherein within said single dynamic object, each of said multiple instances of the given symbol is associated with one or more corresponding hardware and/or software capabilities of a computing platform.

16. The storage medium as recited in claim 15, wherein at least two of said multiple instances are not both operable on a same computing platform.

17. The storage medium as recited in claim 15, wherein said dynamic object is created according to an Executable Linking Format (ELF).

18. The storage medium as recited in claim 17, wherein said program instructions are further executable to:
load said dynamic object at runtime on a given computing platform;
determine capabilities of the given computing platform; and
bind the given symbol to a particular one of said multiple instances in the dynamic object.

19. The storage medium as recited in claim 18, wherein said program instructions are executable to select said particular one of the multiple instances based upon a comparison of the capabilities of the given computing platform and capabilities associated with said multiple instances in the dynamic object.

20. The storage medium as recited in claim 19, wherein said capabilities comprise at least one of the following: the instructions of an instruction set architecture (ISA), the instructions of extensions to the ISA, software features for debugging and monitoring processes, and frame pointer usage state of an object file.
